(19) United States
(12) Patent Application Publication
(10) Pub. No.: US 2013/0003559 A1
(43) Pub. Date: Jan. 3, 2013

(54) Adaptive Power Savings for Aggregated Resources

(75) Inventor: Brad MATTHEWS, San Jose, CA (US)

(73) Assignee: Broadcom Corporation, Irvine, CA (US)

(21) Appl. No.: 13/174,157

(22) Filed: Jun. 30, 2011

(51) Int. Cl. H04L 12/56; H04L 12/26

(52) U.S. Cl. 370/241

(57) ABSTRACT

Embodiments of the present invention are directed to adaptive power savings in aggregated resources in communications devices. According to an embodiment, managing an aggregated resource in a communications device includes monitoring at least one current operational condition of the communications device, identifying based upon a policy configuration and the monitored at least one current operational condition one of the member resources of the aggregated resource as an eligible member resource to configure to a power-saving state, and reassigning traffic flows from the eligible link to at least one other link of the plurality of member resources.

### BACKGROUND OF THE INVENTION

1. Field of the Invention

Embodiments of this invention are related to aggregated resources in communication devices.

2. Background Art

A pair of communications devices can exchange data and control messages over one or more physical links between them. For example, switches and routers may have multiple links connecting them in order to increase the bandwidth between them, and to improve reliability by having redundant resources. Multiple communications links between two devices can also be found internally in communications devices. For example, a switch fabric may connect to a network interface card using multiple communications links.

As the data transmission requirements increase, it becomes necessary to increase the data transfer capacity between devices such as switches and routers that are in the end-to-end communications path. It also becomes necessary to accordingly increase data transfer capacity internal to the various communications devices, such as, the transfer capacity between switch fabric and network interface card.

The increased requirements for data transfer capacity can be accommodated by adding higher bandwidth links. Another approach would be to utilize the multiple links that already exist between two devices to transfer an increased amount of data in parallel over the respective links connecting the same two devices.

Aggregation is a method of logically bundling two or more physical or logical communications resources to form one logical aggregated resource. The aggregated resource can be considered to have the sum bandwidth of the individual links that are bundled. The aggregated link may be considered as a single link by higher-layer protocols (e.g., network layer and above), thus facilitating data transfer at faster rates without the overhead of managing data transfer over separate physical links at the higher-layer protocols. Furthermore, the aggregated link provides redundancy when individual links fail. Typically, link aggregation is implemented at the logical link control layer/media access control layer, which is layer 2 of the Open System Interconnect (OSI) protocol stack.

Relatively recent standards, such as, IEEE 802.3ad and IEEE 802.1ax, have resulted in link aggregation (“LAG”) being implemented in an increasing number of communications devices. Standards, such as those mentioned above, include a control protocol to coordinate the setting up, tear down, and management of aggregated links. The IEEE-specified “Link Aggregation Control Protocol” (LACP) is an example LAG protocol. Some communications devices may implement LAG techniques other than those specified in the standards.

The “Serializer/Deserializer” protocol (“SerDes”) is a commonly used data encoding and transfer method utilizing point-to-point serial links to transfer information between two communications devices or between two components internal to a communications device. SerDes also specifies transferring data in parallel over the multiple links between two devices. A physical port (or physical link) may be referred to herein as a “serdes port (link)” if it is a port or link that operated according to SerDes.

The physical ports or links that are aggregated may include ports configured for Ethernet or other protocols. A physical port or link may be referred to herein as an “ethernet port (link)” if that port or link operates according to the Ethernet protocol.

Various methods are known to assign incoming data flows to respective links of an aggregated link. For example, a hash-based flow identifier, where the flow identifier is determined based upon selected header field values of the packets, may be used to assign an incoming flow to one or more of the links in the aggregated link. Various methods are also known for load balancing so that the current traffic can be distributed among the respective physical links of the aggregated link.

The multiple physical links in an aggregated link, although facilitating increased data transfer capacity between devices, may also lead to increased power consumption. In always-on communications devices, such as routers and switches, such increases can be substantial over time.

Therefore, it is desired that power saving techniques are configured for communications devices with aggregated links.

### BRIEF SUMMARY OF THE INVENTION

Embodiments of the present invention are directed to adaptive power savings in load balanced link aggregates. According to an embodiment, a method for managing an aggregated resource in a communications device includes monitoring at least one current operational condition of the communications device, identifying based upon a policy configuration and the monitored at least one current operational condition one of the member resources of the aggregated resource as an eligible member resource to configure to a power-saving state, and reassigning traffic flows from the eligible link to at least one other link of the plurality of member resources.

Another embodiment is a system for managing an aggregated link in a communications device, including a processor, a memory, an aggregated link including a plurality of communication links and configured for data communication with one or more remote devices, and an adaptive power saving module. The adaptive power saving module may be configured to monitor at least one current operational condition of the communications device, based upon a policy configuration and the monitored at least one current operational condition, identify one of the member resources as an eligible member resource to configure to a power-saving state, and reassign traffic flows from the eligible link to at least one other link of the plurality of member resources.

Another embodiment is a computer readable media storing instructions where the instructions when executed are adapted to manage an aggregated link in a communications device. The method for managing an aggregated resource in a communications device includes monitoring at least one current operational condition of the communications device, identifying based upon a policy configuration and the monitored at least one current operational condition one of the member resources of the aggregated resource as an eligible member resource to configure to a power-saving state, and reassigning traffic flows from the eligible link to at least one other link of the plurality of member resources.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

Reference will be made to the embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates an exemplary system comprising a local communications device and a remote communications device coupled by an aggregated resource, according to an embodiment of the present invention.

FIG. 2 illustrates an exemplary communications device, according to an embodiment of the present invention.

FIG. 3 illustrates an exemplary flow table, according to an embodiment of the present invention.

FIG. 4 illustrates a flowchart of an exemplary method for adaptive power saving in a communications device having an aggregated resource, according to an embodiment of the present invention.

FIG. 5 illustrates a flowchart describing further details of the example method shown in FIG. 4, according to an embodiment of the present invention.

### DETAILED DESCRIPTION OF THE INVENTION

While the present invention is described herein with reference to illustrative embodiments for particular applications, it should be understood that the invention is not limited thereto. Those skilled in the art with access to the teachings herein will recognize additional modifications, applications, and embodiments within the scope thereof and additional fields in which the invention would be of significant utility.

Embodiments disclosed in the specification provides for adaptive power saving in aggregated resources of various communications devices, such as, but not limited to, switches and routers.

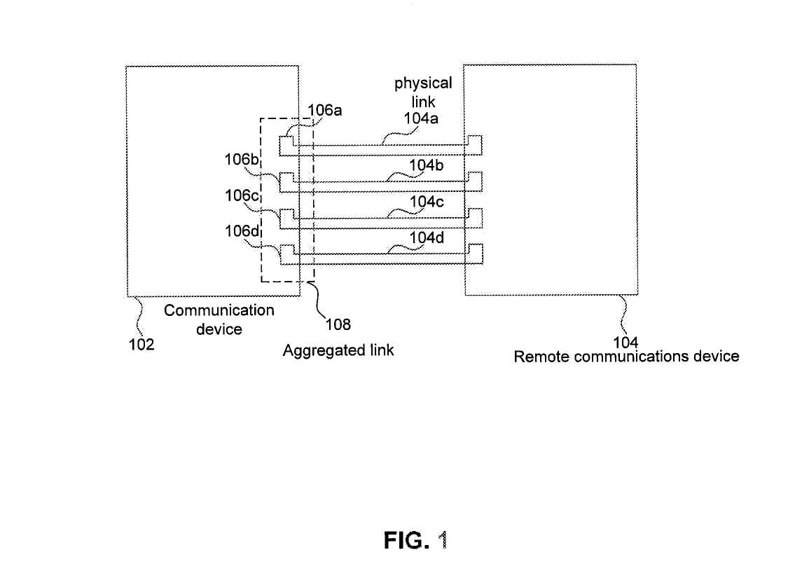

FIG. 1 illustrates an exemplary system 100 according to an embodiment of the present invention. A local communications device 102 and a remote communications device 104 are communicatively coupled using a plurality of physical links 104a-d. The communications devices 102 and 104 can be any type of a communications or computing device. The physical ports associated with the respective physical links 104a-d at the local communications device 102 are referred to as physical ports 106a-d. An aggregated link 108 may be formed by logically aggregating the physical links 104a-d or a subset thereof. Each of the physical links is sometimes referred to as a “member resource.” Correspondingly, the aggregated link is sometimes referred to as a “resource group,” “aggregate,” or “aggregated resource.” In embodiments, a member resource can include, a physical or logical communications link, an egress (i.e. transmit) interface of communications device 102 (such as SerDes interface (not shown)), a next hop (e.g. respective individual ports in the directly connected device(s), or directly connected intermediate device such as a router or switch), or any other destination-based resource. Accordingly, a resource group is a collection of such resources. In particular, as used herein, a resource group is a collection of resources over which the aggregate traffic load should be distributed.

The aggregated link 108 may be formed according to a LAG protocol such as IEEE 802.1ax, IEEE 802.3ad, each of which is incorporated herein by reference, or other LAG protocol. The aggregated link 108 may utilize an aggregate link protocol such as LACP to control the setting up and managing of the aggregated link. For example, the aggregate link protocol would signal between communication devices 102 and 104 to set up aggregated link 108 comprising the individual physical links 104a-104d. In another embodiment, aggregated link 108 may be a HiGig™ trunk. In yet another embodiment, aggregated link 108 may be comprise of a plurality of logical links. For example, in Equal Cost Multipath Routing (ECMP) a logical link may represent a next hop, and an aggregated link 108 may be formed for a plurality of next hops to a particular destination.

According to another embodiment, links 104a-d may couple communications device 102 to two or more other communications devices. For example, links 104 a-b may couple communications device 102 to a first device (not shown) whereas links 104 c-d couple communications device 102 to a second device (not shown). In this embodiment, it is communications device 102 that maintains the aggregated link 108 comprising the four links 104a-d.

A goal of the power saving load balancing operations disclosed herein is to evenly distribute the offered traffic to the individual member resources of the aggregated resource over a time period, while minimizing packet re-ordering and improving power savings. However, it should be understood that although over time a traffic load may be distributed evenly to the individual member resources of the aggregate resource, there may be periods in which one or more of the member resources have a load that is substantially different in size than the other member resources.

For example, with four physical links each running at 10 Gbps, a 20 Gbps offered traffic load may be evenly distributed among the four links by assigning 5 Gbps to each link. However, if another traffic flow is introduced at 3 Gbps, it may be required that the new traffic flow is assigned to only one of the physical links in order to avoid packet reordering that may occur if the traffic is simultaneously distributed over several links of the aggregate. In the event of assigning the new flow to only one of the physical links, the load distribution would not be evenly distributed among all available links because one link will have 8 Gbps whereas the other three links will still have 5 Gbps.

Communications device 102 includes the capability to control the individual physical links 104a-d or corresponding interfaces 106a-d in order to turn the individual links on or off, and/or to change a power mode associated with each physical link. According to an embodiment, communication device 102 may include the functionality of a standard such as IEEE 802.3az Energy Efficient Ethernet (EEE), which is incorporated herein by reference. EEE includes a low power mode in which some functionality of the individual physical links is disabled to save power when the system is lightly loaded. In an embodiment, communications device 102 may include the capability to control physical links 104a-d by controlling the transmission rate on the respective links, for example, to consume less power when transmitting at a lower rate. As referred to in this disclosure, a physical link may be configured to a power-saving state which may include powering off the link, operating the link for data transmission at a low power and low transmission rate, or switching the link to a low power state in which no data is transmitted and control messages may or may not be transmitted. Furthermore, as referred to herein, a physical link may be configured to an active state in which the link is used to transmit data at a normal transmission rate.

Embodiments of the present invention are directed to load balancing (i.e. distributing the offered traffic load) among the individual physical links of the aggregated link while avoiding packet reordering, in a manner that the offered traffic load can be transmitted over the minimum number of physical links so that one or more physical links can be deactivated or set to a low power mode in order to reduce the total power consumed by the aggregated link.

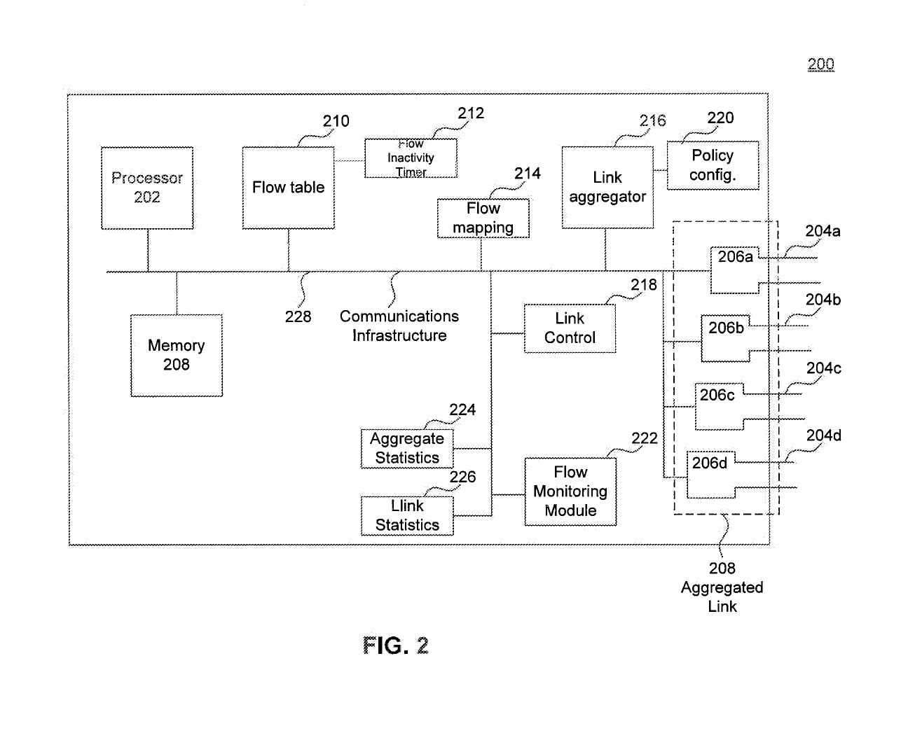

FIG. 2 illustrates an exemplary communications device 200, according to an embodiment of the present invention. Communications device 200 includes a processor 202, a memory 208, physical ports 206a-d corresponding to physical links 204a-d, and a communications infrastructure (also referred to as “bus”) 228.

Processor 202 can include one or more commercially available microprocessors or other processors such as digital signal processors (DSP), application specific integration circuits (ASIC), or field programmable gate arrays (FPGA). Processor 202 can execute logic instructions to implement the functionality of or to control the operation of one or more components of communications device 200.

Memory 208 can include a type of memory such as static random access memory (SRAM), dynamic random access memory (DRAM), or the like. Memory 208 can be utilized for storing logic instructions that implement the functionality of one or more components of communications device 200. Memory 208 can also be used, in embodiments, to maintain configuration information, to maintain buffers (such as queues corresponding to each of the physical ports 206a-d), and to maintain various data structures during the operation of communications device 200. In various embodiments, memory 208 can also include a persistent data storage medium such as magnetic disk, optical disk, flash memory, or the like. Such computer-readable storage mediums can be utilized for storing software programs and/or logic instructions that implement the functionality of one or more components of communications device 200.

Bus 228 may include one or more interconnected bus structures that communicatively couple the various modules of communications device 200. Bus 228 may include, for example, a bus such as, an Advanced High Performance Bus (AHB) that uses a bus protocol defined in the AMBA Specification version 2 published by ARM Ltd, or other internal component interconnection mechanism.

A link aggregator module 216 in the communications device 200 includes logic to form, to tear-down, and to manage an aggregated link 208 which is formed by logically aggregating individual physical links 204a-d. A link control module 218, also in communications device 200, includes logic to, for example, monitor the physical links for activity/inactivity, to turn the physical links on or off, and/or to transition individual links between low power modes and a normal mode. EEE, for example, enables individual links to be configured in low power modes. In some embodiments, individual links may be configured to operate at a lower transmit rate which saves power, or at a normal transmit rate. In some embodiments, logical links may be aggregated to form the aggregated resource. Each logical link, for example, may represent a next hop. Each physical link may include one or more logical links.

A policy configurations module 220 includes configured policy parameters, such as power saving configurations and load balancing configurations, for the aggregated links. Power savings configurations and load balancing configurations may include parameters defining thresholds for operational conditions such as, for example, a desired operating bandwidth for the links, a threshold bandwidth which when exceeded on a link causes additional links to be configured, a minimum number of links in the aggregated link that should be active for redundancy purposes, a threshold maximum operating temperature for the communications device upon reaching which one or more links may be set to a power-saving state, a maximum total power consumption for the communications device upon reaching which one or more links may be set to a power-saving state. Policy configurations may also include time-of-day configurations, wherein when the communication device's system clock evaluates to a configured time-of-day value steps are initiated to transition one or more links to a power-saving state in order to conserve power, or to transition the communications device (or aggregated link) from a power-saving state to a normal operating state.

A flow mapping module 214 includes logic to map incoming traffic flows to a physical port 206a-d of the aggregated link 208. According to an embodiment, flow mapping module 214 can generate a flow identifier (based on predetermined rules, for example) for respective incoming packets and then, if it is a new flow identifier, determine to which of the four physical links 204a-d that flow identifier is to be mapped. The flow identifier of a packet may be determined based upon one or more fields of the packet header. According to one embodiment, a packet may include a field in its header that uniquely identifies the flow, in which case that field may be considered as the flow identifier. According to another embodiment, a flow identifier may be created by combining the header fields destination address, source address, and protocol. Other combinations of header fields may be used to form flow identifiers that uniquely identify a flow, and are contemplated within the scope of the present invention. The mapping may involve mapping from the flow identifier space to a two bit space that maps each flow identifier to exactly one of the four physical links 204a-d. If the flow identifier of the packet matches a flow which has already been assigned to a physical link, then the packet is queued to the corresponding physical port.

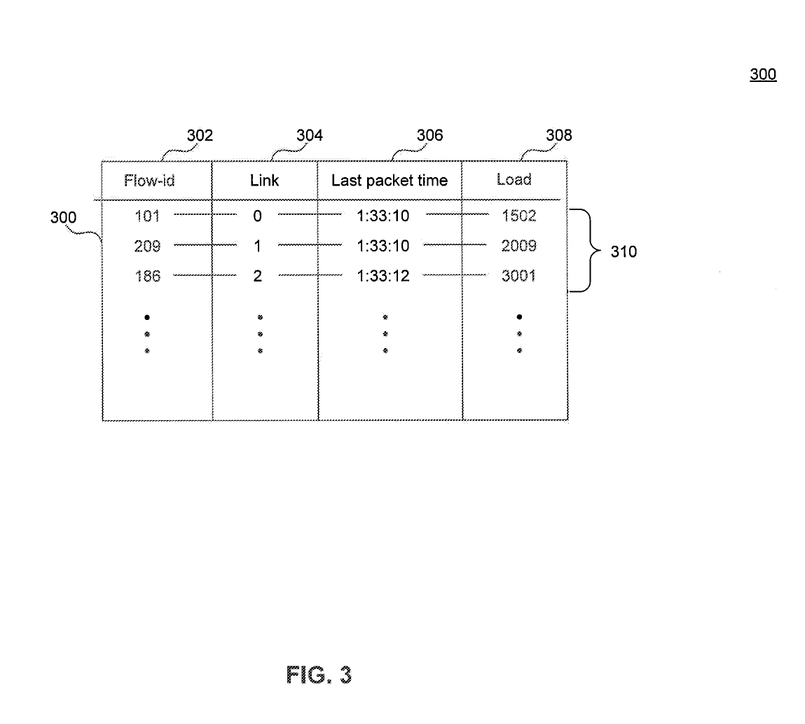

A flow table 210 is configured to maintain information about flows. Specifically, according to an embodiment, flow table 210 includes an entry for each currently active flow indicated by the corresponding flow identifier. According to an embodiment, associated with a flow table 210 is a flow inactivity timer 212 that periodically evaluates the time for which each flow has been inactive (e.g. time since the last packet was enqueued to the corresponding physical port). A flow table is further described in relation to FIG. 3 below.

A flow monitoring module 222, according to an embodiment, includes logic to monitor flows on respective ones of the physical links 204a-d. The monitoring can include, for example, collecting physical link statistics such as the data rate corresponding to a flow over a predetermined interval, the aggregate data rate for the aggregated link 208, and the time at which the last packet was transmitted or received corresponding to the flow. Physical link statistics, such as the traffic load on the respective links, can be stored and maintained in memory 208, in registers 226, or other location. Similarly, aggregated link statistics, such as the total traffic load among all active physical links of the aggregate, can be stored and maintained in memory 208, in registers 224, or other location.

FIG. 3 illustrates an exemplary flow table 300, that can be used to keep track of the flow assignments to respective physical links and current information about the flows. According to an embodiment, flow table 300 includes a column 302 to hold the flow identifier of a flow, a column 304 to identify the physical link to which the flow is assigned, a column 306 to keep track of the time the last packet in the flow was enqueued, and the number of bytes transferred by the flow over a predetermined time period.

The flow identifier can be formed by one or more header fields of the packets or frames. For example, a combination of header fields, such as, the source address, the destination address, and a port or protocol identifier can form a unique identifier for a particular flow. The flow identifier may be the index with which to access the table 300. The time at which the last packet was enqueued is in column 306. According to an embodiment, an instance of the timer 212 keeps track of each respective flow.

When a packet is received at the communication device 200, for example, the flow identifier is formed using the values, and the flow identifier is checked against the flow table 300. If an entry already exists for the particular flow identifier, the packet is mapped to the physical link indicated in the corresponding row of the flow table 200. If an entry corresponding to the flow identifier is not in the flow table 300, the flow is mapped to a physical link, and a new entry is added to the flow table 300 with the flow identifier and its mapped physical link.

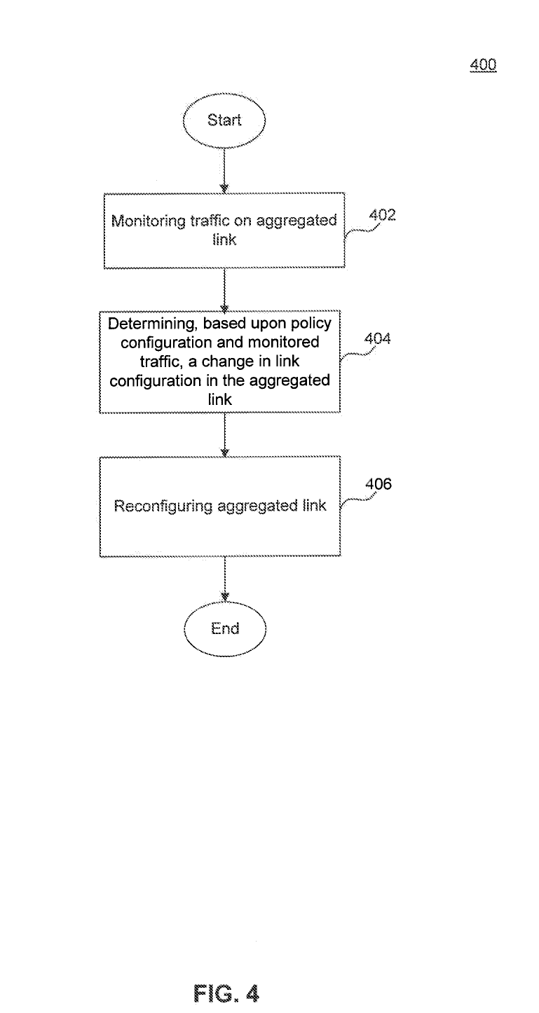

FIG. 4 illustrates a method 400 for power saving load balancing in aggregate resources, according to an embodiment. In step 402, the physical links are monitored to evaluate the load. The traffic monitoring may be performed on a periodically on-going basis or may be performed on a time-of-day basis to evaluate the traffic loading at various times of the day. The total traffic on the aggregated link is determined based on the monitoring of the respective physical links. According to an embodiment, the total traffic for the aggregated link may be determined by summing the load of the individual physical links.

According to another embodiment, the monitoring in step 402 may include another current operational condition in the communications device. For example, the current operating temperature and/or the total power consumption of the communications device may be monitored. In yet another embodiment, the system clock of the communications device may be monitored.

In step 404, based upon a policy configuration and the monitored traffic flows, a change in the link configuration in the aggregated link is determined. According to an embodiment, the total amount of the current load is divided by the capacity of a physical link to determine how many physical links are required to accommodate the current load. According to another embodiment, the number of physical links needed to carry the current load may be determined based on a desired capacity (rather than the actual capacity) of the link. For example, operating the physical links at a rate above a threshold rate may not yield the optimal link configuration for power efficiency. A policy configuration parameter may specify a maximum desired rate at which the links are to be configured. The maximum desired rate, for example, may be the rate at which data is to be transmitted over the particular link in order to optimize power savings. Another configuration parameter, maximum rate, may be used to define the highest rate of the respective links.

According to an embodiment, based upon the current traffic load in the aggregate resource, the number of physical links in the aggregate resource, and optionally including various additional power saving criteria (such as, the maximum desired rate etc.) an initial decision may be arrived at to reconfigure the aggregated link in order to save power.

According to another embodiment, a change in the link configuration of the aggregated link may be determined based upon a policy configuration and another monitored current operational condition such as temperature or total power consumption of the communications device.

In step 406, it is determined which of the links can be reconfigured. According to an embodiment, if the current traffic load can be adequately serviced by less than the number of currently active links, it can be determined that one or more links are to be deactivated or set to a low power mode so that power consumption is reduced. The selection of the actual link to be reconfigured may depend on various criteria including the current load on that particular link. After a link is selected to be set to an inactive state, flows that are currently mapped to that link are reassigned to other links. At the completion of the reassignment the selected link is deactivated (e.g. powered off) or set to low power mode.

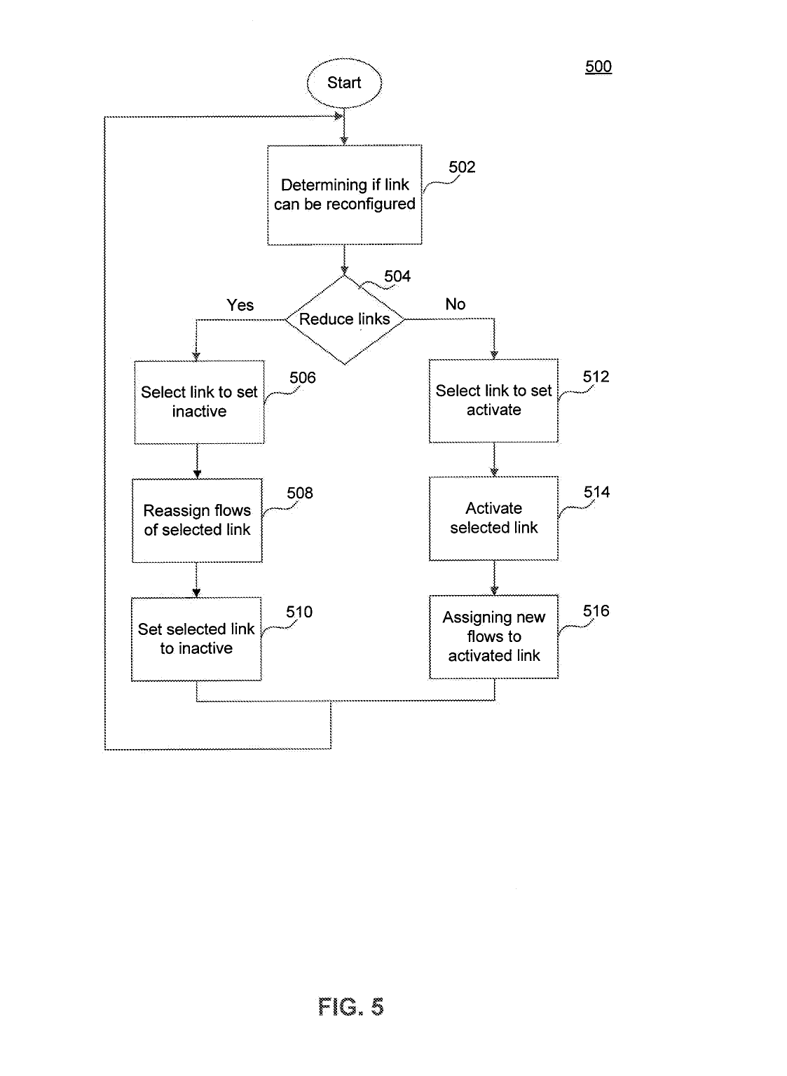

If it is determined that more bandwidth is necessary to accommodate the current load or an expected load, then additional links may be activated. For example, it may be determined that more bandwidth is necessary if the current load is above a threshold bandwidth based on either the actual link bandwidth or a desired level of bandwidth use for optimal power efficiency. Any new flows may then be assigned to the newly activated link. Further description of deactivating and activating of links is set forth below in relation to FIG. 5.

FIG. 5 illustrates a method 500 for reconfiguring physical links in order to save power and load balance aggregated links, according to an embodiment of the present invention. In step 502, it is determined what action needed to be taken with regard to saving power and load balancing. The determination whether to deactivate (e.g. power off or set to low power state) any physical links may be based upon the current traffic load in the aggregated link, the number of currently active physical links in the aggregated link, the capacity of the respective physical links, and policy considerations. The policy considerations can include factors such as, the desired maximum loading of each physical link, and a minimum number of active links to be active in an aggregated link (for example, for redundancy purposes).

Similarly, based upon the current traffic load it may be determined that additional links are required to be activated to accommodate any new incoming flows. For example, a policy configuration setting may specify a threshold loading level of currently active links at which new links are activated.

Accordingly, in step 504 it is determined whether to deactivate one or more currently active links, or to activate one or more currently inactive links. If physical links are to be deactivated processing proceeds to step 506. If, on the other hand, new physical links are to be activated, processing proceeds to step 512.

In step 506, the one or more links to be deactivated are determined. As described above, the number of links to be deactivated may be dependent upon the current traffic load in the aggregated link and one or more other considerations. Whether a particular link is a candidate to be deactivated or set to low power can be determined based upon what flows are currently assigned to the physical link, and the characteristics of those flows. According to am embodiment, the physical link with the least active flows may be selected as the primary candidate for deactivation because less active flows can be more readily reassigned to other links with reduced risk of causing out-of-order packets. According to another embodiment, the physical link with the least number of flows is selected as the primary candidate for deactivation because it would involve reassigning the least number of flows to other physical links.

The activity levels of the respective flows can be determined from the flow table as well as from the packet queues at the physical ports. The flow table, according to an embodiment, indicates the last time when a packet was received for each physical link. The queue associated with that a physical link would have the packets yet to be transmitted.

The time duration required to transmit all currently enqueued packets of a particular flow on a physical link can be determined. For example, the duration may be based upon the number of packets yet to be transmitted on the physical link before the last of the packets enqueued for the particular flow is transmitted, the size of the packets, and the rate of the physical link. According to an embodiment, the determined duration may also be affected by the dequeuing discipline (i.e. the ordering with which packets to be transmitted are removed from the queues at the output port) employed. For example, if packets are dequeued according to the first-in-first-out (FIFO) discipline, then the last of the packets for the particular flow will only be dequeued after all other packets queued ahead of it are transmitted. However, other queueing disciplines, such as priority-based dequeuing may be employed, and are contemplated within the teachings of this disclosure. The time to dequeue all enqueued packets of the flow to be reassigned is calculated in a manner that accounts for the specific queue discipline.

A goal is to perform the reassignment of the flows in a manner that packets are not sent to the destination out of order. In order to ensure that packets of a reassigned flow do not arrive at the destination out of order, it must be ensured that the first packet of the reassigned flow (i.e. first packet of the flow after the reassignment to another physical link) is received at the destination only after the last packet of that flow on the current link (i.e. physical link prior to the reassignment) is received.

Given a particular flow being considered for reassignment, in a first configuration where the currently assigned link and the to be assigned link both have the same estimated time to reach the destination, out of order packets can be avoided by ensuring that the last packet of the flow from the currently assigned queue is transmitted before the first packet from the flow on the reassigned link is transmitted.

According to another embodiment, in which the time to reach the destination is different between the currently assigned link and the link to be reassigned, that time difference is considered in addition to the time to transmit the last packet of the flow from the currently assigned link and the first packet of the flow from the queue of the newly reassigned link.

Based upon the considerations described above, each of the flows of the link to be deactivated are reassigned to other selected links in step 508. When a flow is reassigned, the mapping of the flow is changed accordingly in the flow table, and any newly arriving packets are enqueued to the reassigned link. As described above, a key consideration is that the first packet of the flow from the reassigned link does reaches the destination after the last packet from that flow from the currently assigned link.

The reassignment of the flows may be performed flow by flow, avoiding potential packet reordering situations, until all the flows that were previously assigned to the link have been reassigned. According to another embodiment, the reassignment of the flows may be done on a macroflow basis. For example, all the flows assigned to a link that have the same destination may be considered a macroflow, and the reassignment of the macroflow can be performed as a single operation.

After completing the reassignment of all flows that were previously assigned to the link, in step 510, the link is set to inactive. According to another embodiment, for example, according to the EEE standard, the link may be set to a low power mode. In either case, in step 510 the link is removed from actively servicing the normal flow of traffic, and is transitioned to a state in which power consumption for the aggregated link is reduced.

If, in step 504, it was determined that a new physical link should be activated, then in step 512, a currently inactive physical link is selected tor activation. According to an embodiment, any of the currently inactive links can be selected. According to another embodiment, for example, when physical links in an aggregated link have different transmission characteristics (e.g. bandwidth, queue size), the determination as to which of the currently inactive links are to be activated may be made based on policy configurations.

In step 514, the link is activated. Activating the link may include either powering on the link, or transitioning the link from the low power mode to the normal transmission mode.

After the new link is activated, in step 516, new flows are assigned to the newly activated link. If a new flow is already pending assignment that flow is assigned to the newly activated link and the flow table is updated accordingly.

The representative functions of the communications device described herein can be implemented in hardware, software, or some combination thereof. For instance, processes 400 and 500 can be implemented using computer processors, computer logic, ASIC, FPGA, DSP, etc., as will be understood by those skilled in the arts based on the discussion given herein. Accordingly, any processor that performs the processing functions described herein is within the scope and spirit of the present invention.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for managing an aggregated resource in a communications device, comprising:
monitoring at least one current operational condition of the communications device;
identifying, based upon a policy configuration and the monitored at least one current operational condition, one of the member resources of the aggregated resource as an eligible member resource to configure to a power-saving state; and
reassigning traffic flows from the eligible member resource to at least one other member resource of the plurality of member resources.

2. The method of claim 1, further comprising:
configuring the eligible member resource to a power-saving state after the reassigning.

3. The method of claim 1, wherein each of the member resources is a physical communications link.

4. The method of claim 1, wherein each of the member resources is a logical communications link.

5. The method of claim 1, wherein the identifying step comprises:
determining, based upon the monitoring, a total amount of traffic flow in the aggregated resource;
determining a reduced number of member resources to service the total amount of traffic flow; and
determining specific ones of the plurality of member resources to be set to a power-saving state such that only the reduced number of member resources are active in the aggregated resource.

6. The method of claim 5, wherein determining specific ones of the plurality of member resources to be set to a power-saving state step comprises:
determining for respective traffic flows currently assigned to the eligible member resources a reassignment time at which to perform reassignment; and
changing the assignment of the respective traffic flows at the determined reassignment time.

7. The method of claim 6, wherein the determining the reassignment time comprises:
computing the reassignment time such that reordering of packets is minimized.

8. The method of claim 7, wherein the computing step comprises:
determining a number of currently enqueued data units for the respective traffic flow;
determining a duration in which the currently enqueued data units can be transmitted; and
determining the reassignment time based on a current time and the determined duration.

9. The method of claim 8, further comprising:
determining respective delays for the respective traffic flow to a destination over the eligible member resource and over a second one of the plurality of member resources, wherein the respective traffic flow is to be reassigned to the second one of the member resources; and
determining the reassignment time based on the respective delays in addition to the current time and the determined duration.

10. The method of claim 5, wherein the reduced number of member resources is a minimum number of member resources required to service the total amount of traffic flow.

11. The method of claim 1, wherein the identifying step comprises selecting one of the member resources with least active traffic flows as the eligible member resource.

12. The method of claim 1, wherein the identifying step comprises selecting one of the member resources with a lowest number of traffic flows as the eligible member resource.

13. The method of claim 1, wherein the at least one current operational condition includes traffic flows to the plurality of member resources from the communications device.

14. The method of claim 13, further comprising:
detecting an increase in the monitored traffic flows;
responsive to the detection of the increase, reconfiguring the eligible member resource to an active state; and
assigning new traffic flows to the reconfigured eligible member resource.

15. The method of claim 1, wherein the at least one current operational condition includes a temperature of the communications device.

16. The method of claim 1, wherein the at least one current operational condition includes a power usage of the communications device.

17. The method of claim 1, wherein the at least one current operational condition includes a system time of the communications device.

18. A system for managing an aggregated resource in a communications device, comprising:
a processor;
a memory, communicatively coupled to the processor;
an aggregated resource communicatively coupled to the processor, the aggregated resource including a plurality of member resources and configured for data communication with one or more remote devices; and
an adaptive power saving module communicatively coupled to the processor and configured to:
monitor at least one current operational condition of the communications device;
identify, based upon a policy configuration and the monitored at least one current operational condition, one of the member resources as an eligible member resource to configure to a power-saving state; and
reassign traffic flows from the eligible member resource to at least one other member resource of the plurality of member resources.

19. The system of claim 18, further comprising an Energy Efficient Ethernet link management module communicatively coupled to the processor and configured to reconfigure the eligible member resource to a power-saving state.

20. The system of claim 18, wherein the adaptive power saving module is further configured to configure the eligible member resource to a power-saving state after the reassigning.

21. The system of claim 20, wherein the adaptive power saving module is further configured to:
detect an increase in traffic flows in the aggregated resource;
responsive to the detection of the increase, reconfigure the eligible member resource to an active state; and
assign new traffic flows to the reconfigured eligible member resource.

22. The system of claim 18, wherein the power-saving state comprises one of a powered off state or a low power state.

23. A computer readable media storing instructions wherein said instructions when executed by a processor, cause the processor to manage an aggregated resource in a communications device using operations comprising:
monitoring at least one current operational condition of the communications device;
identifying, based upon a policy configuration and the monitored at least one current operational condition, one of the member resources of the aggregated resource as an eligible member resource to configure to a power-saving state; and
reassigning traffic flows from the eligible member resource to at least one other member resource of the plurality of member resources.
